(19) United States
(12) Patent Application Publication
(10) Pub. No.: US 2006/0248779 A1
(43) Pub. Date: Nov. 9, 2006

(54) In-line fishing weight holder

(76) Inventor: Brian Settele, Glendale, WI (US)

Correspondence Address: RYAN KROMHOLZ & MANION, S.C., POST OFFICE BOX 26618, MILWAUKEE, WI, 53226, US

(21) Appl. No.: 11/397,366

(22) Filed: Apr. 4, 2006

Related U.S. Application Data
(60) Provisional application No. 60/669,078, filed on Apr. 7, 2005.

(51) Int. Cl. A01K 91/00

(52) U.S. Cl. 43/43.12

(57) ABSTRACT

An in-line fishing weight holder is disclosed, which has a first free end coupled with a line engaging curvature. The fishing weight holder carries a weight of desired amount. In use, the angler attaches the in-line fishing weight holder to the fishing line by means of a hitch, which can be easily detached by merely slipping the hitch over the first free end of the in-line fishing weight holder.

### RELATED APPLICATION

This application claims the benefit of U.S. Provisional Patent Application Ser. No. 60/669,078, filed 7 Apr. 2005, and entitled “In-Line Fishing Weight Holder.”

### BACKGROUND OF THE INVENTION

This invention relates to in-line trolling weights for fishing. In-line trolling weights, often referred to as snap weights, are simple, effective and easy to use. These weights are detachably affixed to fishing line between the lure and the rod/reel to assist the lure in swimming at a desired depth.

Unlike many alternative weights that must be attached to the fishing line in-line trolling weights are easily installed and removed from the line with having to tie and retie knots. Beneficially, the distance from the weight to the lure can be easily altered to have greater control on the depth of the lure. Additionally, the amount of the weight can also be altered, also adding control to the depth of the lure, which has been determined as critical to successful angling.

One prior art system, known as the “Off Shore Tackle OR-16 Snap Weight Clip” is similar to a pinch pad style planer board release. A weight is attached to a pinch pad, and the pinch pad is then removably attached to the fishing line. The size of the weight can be changed according to user preference. These devices are disclosed in attached Appendix A, incorporated herein by reference. In those devices, the snap weight clip is desired to be attached at a predetermined place on the fishing line.

In use, the weights take the bait to the desired depth and remain in that position while trolling. Once a fish is hooked, the line is reeled in, and the weight is removed once it reaches nearly the rod tip. It is critical to have the ability to quickly remove the snap weight, as tension is desirably maintained on the fishing line between the rod/reel and the fish.

### SUMMARY OF THE INVENTION

According to the present invention, an alternative to the prior art pinch pad is disclosed.

In one embodiment of the present invention, the in-line fishing weight holder of the present invention comprises a first free end coupled with a line engaging curvature, the line engaging curvature coupled to a weight engaging structure, which carries a weight of desired amount.

In use, the angler attaches the in-line fishing weight holder to the fishing line by means of, for instance, a cow hitch, shown in Appendix B, or a Larkhead knot.

The in-line fishing weight holder carrying the weight is trolled in the usual way.

During retrieval of the in-line fishing weight holder/weight, and the lure behind it, the in-line fishing weight holder/weight can be easily detached by merely slipping the fishing line over the first free end of the in-line fishing weight holder.

### BRIEF DESCRIPTION OF THE DRAWINGS

FIG. 1 is an embodiment of in-line fishing weight holder of the present invention, the in-line fishing weight holder carrying a swivel and a weight;

FIG. 2 is an alternate embodiment of in-line fishing weight holder of the present invention;

FIG. 3 shows the hitch in the fishing line about the in-line fishing weight holder.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

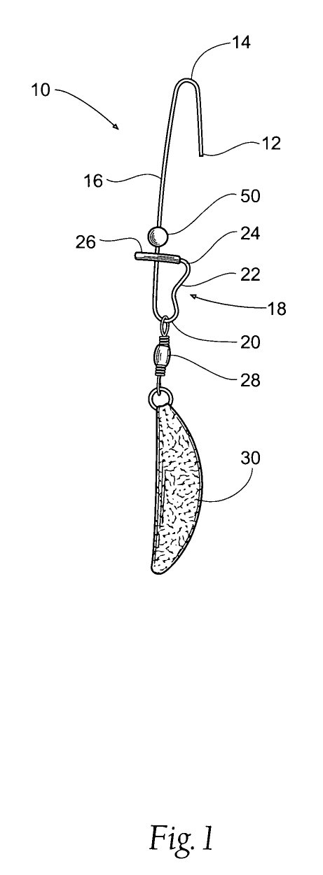

Referring now to FIG. 1, an embodiment of in-line fishing weight holder 10 is shown. The in-line fishing weight holder 10 is shown carrying a swivel 28 and a weight 30, the size of which can be varied according to user preference.

The in-line fishing weight holder 10 comprises a first free end 12, coupled to a line engaging curvature 14, the point at which the fishing line will be attached as described later. A run 16 couples the line engaging curvature 14 with the weight engaging structure 18, which comprises a weight cradle portion 20, an indented portion 22 for urging the weight into the cradle portion 20, and a closing curvature 24 which creates a loop over the run 16, to selectively retain the swivel 28 and weight 30 in the weight engaging structure 18. An optional shrink wrapping 26 can be applied to the closing curvature 24 depending on user preference. A bead 50 with a void therethrough, may be placed about run 16 so that the fishing line (shown later) does not become entangled with the closing curvature 24.

Weight 30 may or may not be supplied with swivel 28, it being understood that other methods of attachment are commonplace in the art. Further, weight 30 may be of any size and shape, depending on the speed at which the angler desires to troll, the current the angler is fishing in, or otherwise.

Referring now to FIG. 2 an alternate embodiment of the in-line fishing weight holder 10 of the present invention is shown. In this embodiment, the weight engaging structure 18 is varied from that shown in FIG. 1. The point of this embodiment is that the weight engaging structure can vary widely from that shown or described herein without departing from the scope of the invention.

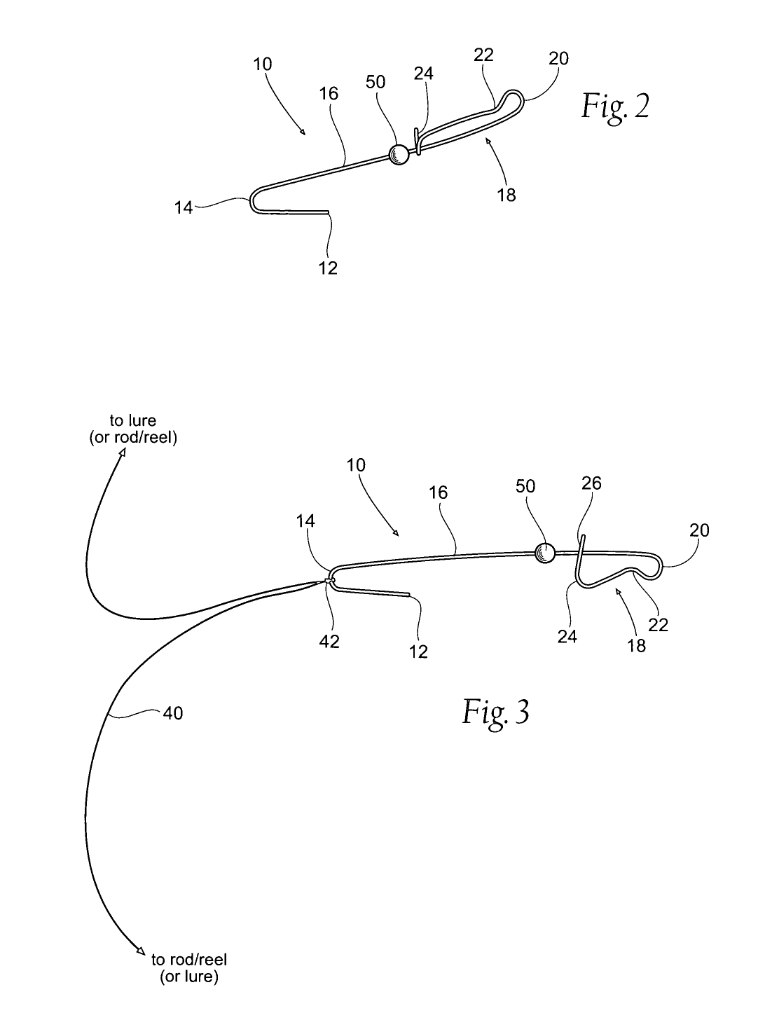

Referring now to FIG. 3, a fishing line 40 is shown coupled to the line engaging curvature 14. A hitch 42, preferably the easy-to-tie cow hitch described in Appendix B, is formed in the fishing line, and the first free end 12 is fed through the hitch 42 to couple the line 40 with the in-line fishing weight holder 10. The line 40 will depart from the curvature 14 in two directions, one to the rod/reel (not shown), and the other to the lure (not shown).

As the weight 30 will cause the in-line fishing weight holder 10 to run generally vertically in the water column, the line 40, particularly the hitch 42, will not slip off of the free end during trolling, as the free end 12 will be below the hitch 42, the hitch being urged upward vertically in the water column by the pressure on the line 40 applied by the tension between it at the rod/reel combination. As such, the line 40 will be urged to remain in the line engaging curvature 14.

During retrieval, when it is desired that the in-line fishing weight holder 10 be removed, the angler retrieves the line 40, along with the in-line fishing weight holder 10, and the weight 30, and the lure behind the in-line fishing weight holder 10. The angler can simply slide the hitch 42 over the free end 12, to allow the remainder of the line 40 to be retrieved, hopefully along with the lunker that ate the lure (not shown).

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. An in-line fishing weight holder comprising:
a first free end;
a line engaging structure coupled to said first free end;
a run coupled with said line engaging structure;
a weight holding structure coupled with said run;
a closing curvature coupled with said weight holding curvature.

2. An in-line fishing weight holder in accordance with claim 1, said in-line fishing weight holder further comprising:
a closing structure coupled with said closing curvature, said closing structure coupling about said run, said closing structure creating a closed loop between a portion of said run, said weight holding curvature and said closing curvature.

3. An in-line fishing weight holder in accordance with claim 1, said weight holding curvature carrying a weight.

4. An in-line fishing weight holder in accordance with claim 1, said line engaging structure carrying fishing line.

5. An in-line fishing weight holder in accordance with claim 1, said run carrying a bead.

6. An in-line fishing weight holder in accordance with claim 1, said in-line fishing weight holder further comprising:
a protective wrapping about at least a portion of said fishing weight holder.

7. An in-line fishing weight holder in accordance with claim 1, said in-line fishing weight holder further comprising:
an indent coupled with said weight holding structure.

8. An in-line fishing weight holder comprising:
a first free end;
a line engaging structure coupled to said first free end;
a run coupled with said line engaging structure;
a weight holding structure coupled to said run, said weight holding structure comprising a weight cradle portion and a closing structure, said weight holding structure for retaining said weight.

9. An in-line fishing weight holder in accordance with claim 8, said weight holding structure further comprising an indent for urging said weight into said weight cradle portion.

10. An in-line fishing weight holder in accordance with claim 8, said weight holding structure further comprising closing structure for engagement about said run.
